(19) United States
(12) Patent Application Publication
(10) Pub. No.: US 2003/0069777 A1
(43) Pub. Date: Apr. 10, 2003

(54) Integrated system for providing remote outsourcing of services

(76) Inventor: Zvi Or-Bach, San Jose, CA (US)

Correspondence Address: VENABLE, BAETJER, HOWARD AND CIVILETTI, LLP, P.O. BOX 34385, WASHINGTON, DC, 20043-9998, US

(21) Appl. No.: 10/291,828

(22) Filed: Nov. 12, 2002

Related U.S. Application Data
(63) Continuation-in-part of application No. 09/494,372, filed on Jan. 31, 2000, now abandoned.

(51) Int. Cl. G06F 17/60

(52) U.S. Cl. 705/9

(57) ABSTRACT

An integrated system for providing remote outsourcing of services includes at least one local service center located relatively near to users and being operative to communicate with the users via communications media, at least one remote service center located relatively far from the users and communicating with service providers who are located closer to the remote service center than to at least most users, and an at least partially dedicated high speed communications link interconnecting the local and remote service centers, and wherein the service providers provide at least secretarial services for the users and communicating their work product via the remote service center, the high speed communications link and the local service center to the users.

### CROSS-REFERENCE TO RELATED APPLICATION

This application is a continuation-in-part of U.S. patent application Ser. No. 09/494,372, filed on Jan. 31, 2000, entitled, “Integrated System for Providing Remote Outsourcing of Services,” and incorporated herein by reference in its entirety.

### FIELD OF THE INVENTION

The present invention relates to the integration of business methods and communications.

### BACKGROUND OF THE INVENTION

Modern times have seen a revolutionary increase in the accessibility of global communications and a corresponding decrease in the real cost thereof. In developed countries there has developed a corresponding decrease in the availability of skilled workers in many fields and a concomitant increase in the cost thereof.

In the past, disparity in wages of relatively unskilled workers have resulted in manufacturing being outsourced to locations in low wage regions. Although this has produced significant economies, such economies are limited by the costs and delays inherent in shipping goods over large distances.

### SUMMARY OF THE INVENTION

The present invention seeks to provide a business and communications framework that enables outsourcing of services from regions of relatively high cost and limited availability to regions of relatively low cost and relatively unlimited availability.

There is thus provided in accordance with a preferred embodiment of the present invention a system for providing cost effective outsourcing of services, the system including at least one local service center located relatively near to users and being operative to communicate with the users via various communications media, at least one remote service center located relatively far from the users and communicating with service providers who are located closer to the remote service center than to the users and an at least partially dedicated high speed communications link interconnecting the local and remote service centers, the service providers providing, for example, secretarial services (or, in general, any services that may be provided remotely) for the users and communicating their work product back to the users via the remote service center (which communicates the work product through the at least partially dedicated high speed communications link, from which it proceeds to the local service center and then to the users).

There is also provided in accordance with a preferred embodiment of the present invention a method for providing cost effective outsourcing of services, the method including having users communicate with a local service center located relatively near to them via various communications media, having service providers located closer to a remote service center located relatively far from the users than to the users communicate with the remote service center, interconnecting the local and remote service centers via an at least partially dedicated high speed communications link, wherein the service providers provide, for example, secretarial services (or, in general, any service that may provided remotely) for the users and communicate their work product back to the users via the remote service center (which communicates the work product through the at least partially dedicated high speed communications link, from which it proceeds to the local service center and then to the users).

In accordance with a preferred embodiment of the present invention, the service providers are located in a region of the world wherein wages are relatively low in comparison with wages for providing the same services in a region where users are located.

Additionally in accordance with a preferred embodiment of the present invention, the service providers provide at least one of the following services: typing, translating, transcription, travel agent services, ticket agent services, product purchasing, services purchasing, arrangements (i.e., concierge-type services), scheduling meetings, restaurant reservations, call screening, call forwarding, providing reminders, e-mail screening, surveillance, actuation of appliances, teaching and web browsing.

Further in accordance with a preferred embodiment of the present invention, the system and method provide some or all of the services at no cost or a cost less than their market value to the users.

In accordance with a preferred embodiment of the present invention, one or both of the local service center and the remote service center may be virtual.

Further in accordance with a preferred embodiment of the present invention, the communication between the user and the local service center is multimedia communication.

Additionally, in accordance with a preferred embodiment of the present invention, the communication between the service provider and the remote service center is multimedia communication.

Further in accordance with a preferred embodiment of the present invention, the communication between the user and the local service center is wireless communication.

Additionally, in accordance with a preferred embodiment of the present invention, the communication between the service provider and the remote service center is wireless communication.

Further in accordance with a preferred embodiment of the present invention, the communication between the user and the service provider is real time communication.

### BRIEF DESCRIPTION OF THE DRAWINGS

The present invention will be understood and appreciated more fully from the following detailed description, taken in conjunction with the drawings, in which:

FIG. 1 is a simplified pictorial illustration of an integrated services outsourcing system constructed and operative in accordance with a preferred embodiment of the present invention;

FIG. 2 is a simplified flowchart illustrating the principal operational features of the system of FIG. 1; and

FIGS. 3A-3M are flowcharts illustrating some exemplary features of the system of FIG. 1 in greater detail.

### DETAILED DESCRIPTION OF PREFERRED EMBODIMENTS

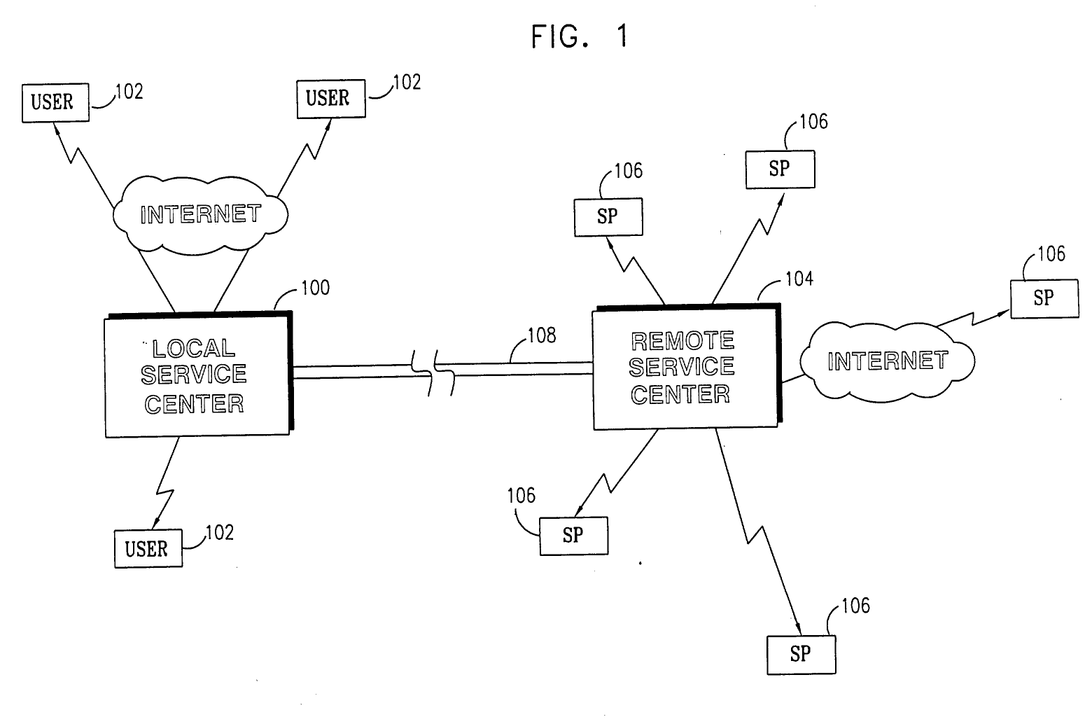

Reference is now made to FIG. 1, which illustrates an integrated services outsourcing system constructed and operative in accordance with a preferred embodiment of the present invention.

As seen in FIG. 1, the integrated services outsourcing system of the present invention preferably includes at least one local service center 100 located relatively near to users 102 and being operative to communicate with the users 102 via various communications media.

Communications between users 102 and local service center 102 may be via voice, facsimile, video and/or data links over wired or wireless telephone or other communication links. The communications may be via a conventional PSTN network, via the Internet or via any other suitable carrier. The users may be static or mobile.

At least one remote service center 104 is normally located relatively far from at least most users and communicates with service providers 106, who are normally located closer to the remote service center 104 than to the users. An at least partially dedicated high speed (and thus high capacity) communications link 108 preferably interconnects each local service center 100 with one or more remote service centers 104. By “at least partially dedicated” it is meant that at least a portion of link 108 is used primarily or only for traffic between the local and remote service centers. By using such an at least partially dedicated high speed communication link, larger volumes of communication (i.e., jobs and work product) may be communicated between the users and the service providers at a faster rate than if a non-dedicated link (e.g., PSTN or Internet) were used. Such an at least partially dedicated high speed link might comprise one or more two-way links or at least a pair of one-way links. It might be implemented, for example, by one or more fiber-optic links, satellite links, T1 lines, etc., which may be, for example, owned or leased by a proprietor of the outsourcing system.

The arrangement of local service center 100, remote service center 104, and communication link 108 is also advantageous over an arrangement in which local service center 100 and remote service center 104 are merged into a single (combined) service center jointly accessed by users and service providers. The advantage lies in that, particularly where the regions in which the users and service providers are very distant from each other, to allow for the economic advantage of different costs of living and the resulting costs of services. Moreover, the objective is to utilize communication for services that otherwise might have been provided through direct contact, therefore the quality of the communication link has impact on the quality of service. Because the service providers are located at a location where the cost of living is relatively low (as will be explained below), it would in most case imply a lower quality and higher cost of the general communications infrastructure between potential services providers and service users. It is, therefore, a major advantage of the current invention to provide an at least partially dedicated link that allows a lower cost and higher quality of communication between service providers and users.

In accordance with a preferred embodiment of the present invention, the service providers 106 provide, for example, secretarial services for the users 102. Service providers 106 receive work from remote service center 104 and communicate their work product back to remote service center 104. From remote service center 104, the work product is communicated back through communications link 108 to a local service center 100, from which it is communicated to the users 102.

As seen in FIG. 1, the service providers 106 are typically remote from the remote service center 104 and communicate with the remote service center 104 via voice, video, facsimile and/or data links over wired or wireless telephone or other communication links. The communications may be via a conventional PSTN network, via the Internet or via any other suitable carrier.

In accordance with a preferred embodiment of the present invention, the service providers are located in a region of the world wherein wages are relatively low but where persons who are trainable to have the requisite skills are readily available. In particular, the service providers are advantageously located in a region where the wages paid for doing the type of work requested by the users are lower than they are in the region where the users are located. For example, a user in one city may have to pay, say, $10.00 per hour for transcription services if she hires someone in that city to do the transcription. On the other hand, someone located in a distant city or country may be willing to perform the same transcription for only 10¢ per hour. In this manner, even if a system proprietor (i.e., the one(s) who own(s) and/or operate(s) the service centers and the communication link) is able to charge a premium, above the cost of the services, and still charge the users less than they would otherwise pay for the services.

The service providers may provide purely secretarial services, like typing and transcription. However, the service providers are not limited to such services and may provide other services. Hence, a service provider may provide a whole range of services that may include any or all of the following examples: typing, translating, travel agent services, ticket agent services, product purchasing, services purchasing, arrangements (e.g., concierge-type services), scheduling meetings, restaurant reservations, call screening, call forwarding, providing reminders, email screening, surveillance, actuation of appliances, teaching and web browsing.

In accordance with one preferred business model, in accordance with a preferred embodiment of the present invention, the system and method provide some or all of the services at no cost or at a cost less than their market value to the users. In such a case, revenues may accrue from at least one of advertising to the users and commissions on products and services purchased by or on behalf of the users via the system.

As illustrated in FIG. 1, one or both of the local service center and the remote service center may be virtual.

Preferably, the communication between the user and the local service center is multimedia communication. Similarly, the communication between the service provider and the remote service center is preferably multimedia communication. Such communication may be via wired and/or wireless media.

In accordance with a preferred embodiment of the present invention, communication between the user and the service provider is real time communication. In such a way, it is anticipated that a personal connection may be established between a user and a service provider, notwithstanding very substantial geographical distances between them.

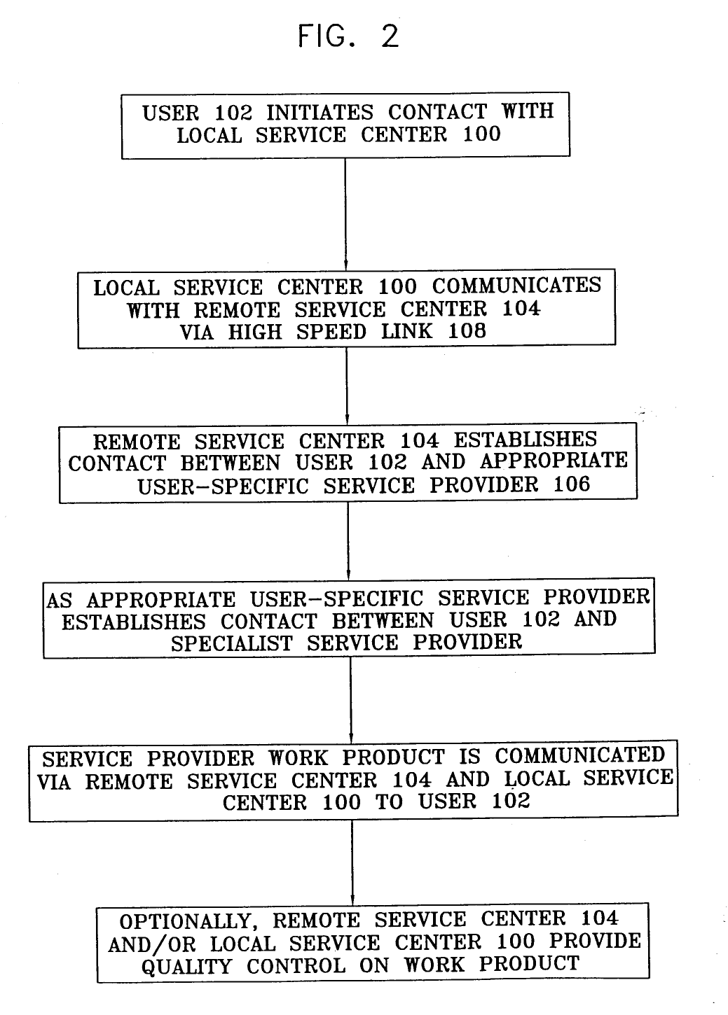

Reference is now made to FIG. 2, which is a simplified flowchart illustrating the principal operational features of the system of FIG. 1. As seen in FIG. 2, a user, whether static or mobile, may initiate contact with a local service center 100, preferably via the Internet but alternatively via any other suitable communications medium or media. The user's communication with the local service center 100 may be via data communication, or voice communication or any other type of communication, or a combination thereof.

The local service center 100 establishes real time communication via at least partially dedicated high speed link 108 with the remote service center 104. Depending on the services requested, the remote service center 104 establishes communication between the user 100 and an appropriate service provider or service providers 106.

In accordance with a preferred embodiment of the invention, the service providers 106 may include user-specific service providers who are permanently assigned to one or more specific users and are thus generally familiar with the user's requirements and preferences. In-certain cases, when specialist services are required, the user-specific service providers establish communication between the user and an appropriate specialist service provider.

Work product provided by the service providers 106 is communicated via the remote service center 104, which may perform quality control thereon, and via the local service center 100, which alternatively or additionally may provide quality control, to the user via an appropriate communication medium or media. The quality control, when carried out at the remote service center 104, is preferably carried out by the user-specific service provider prior to communication of the work product to remote service center 104.

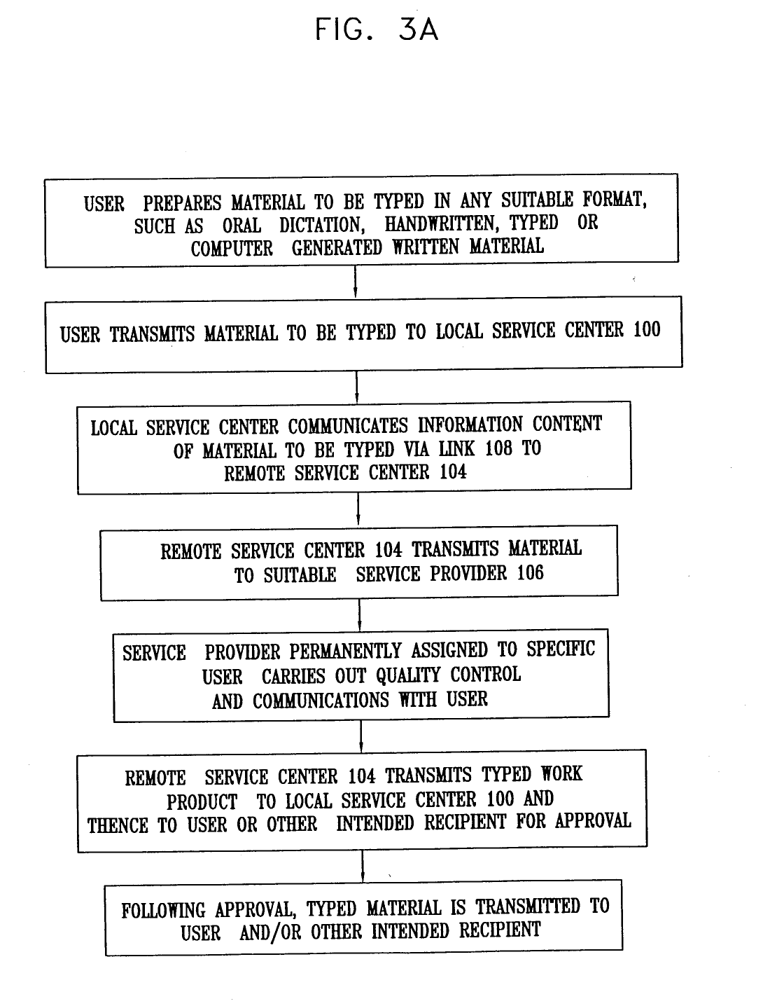

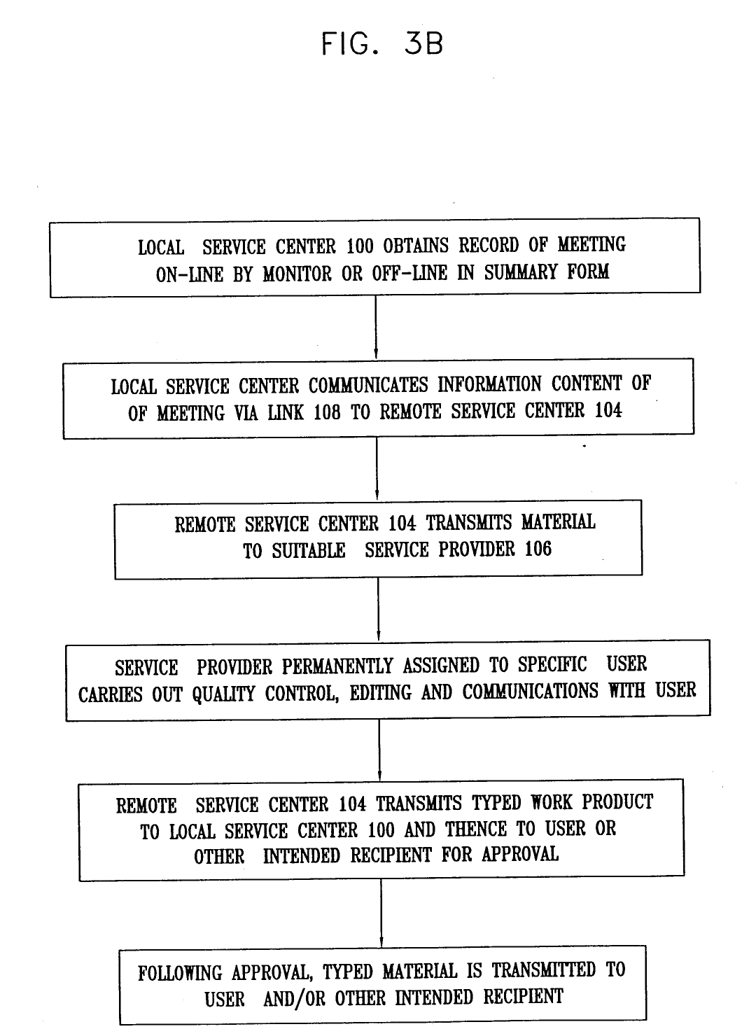

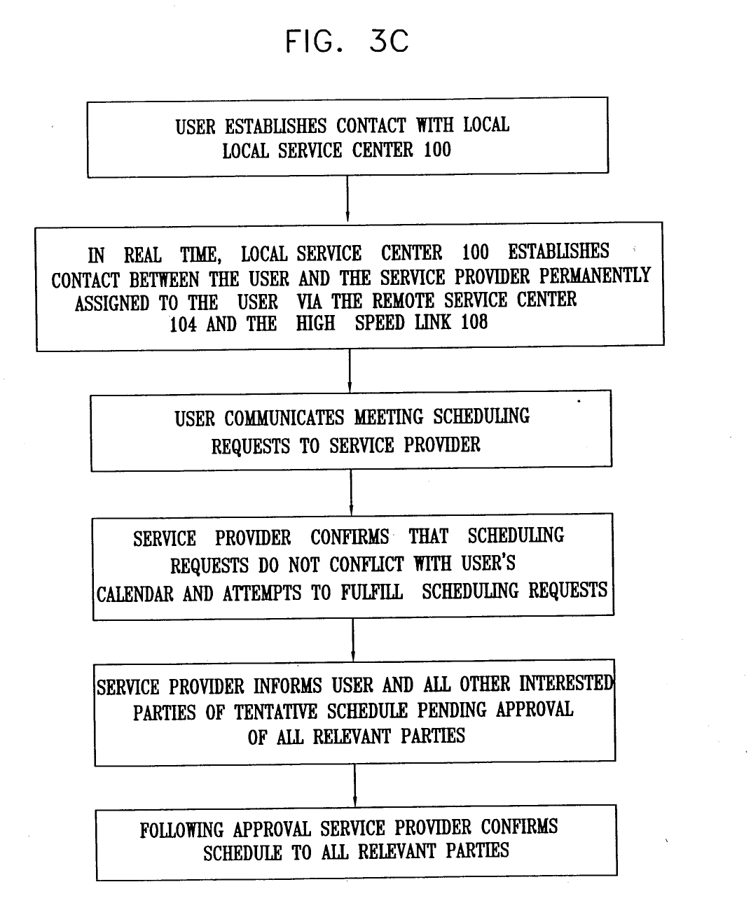

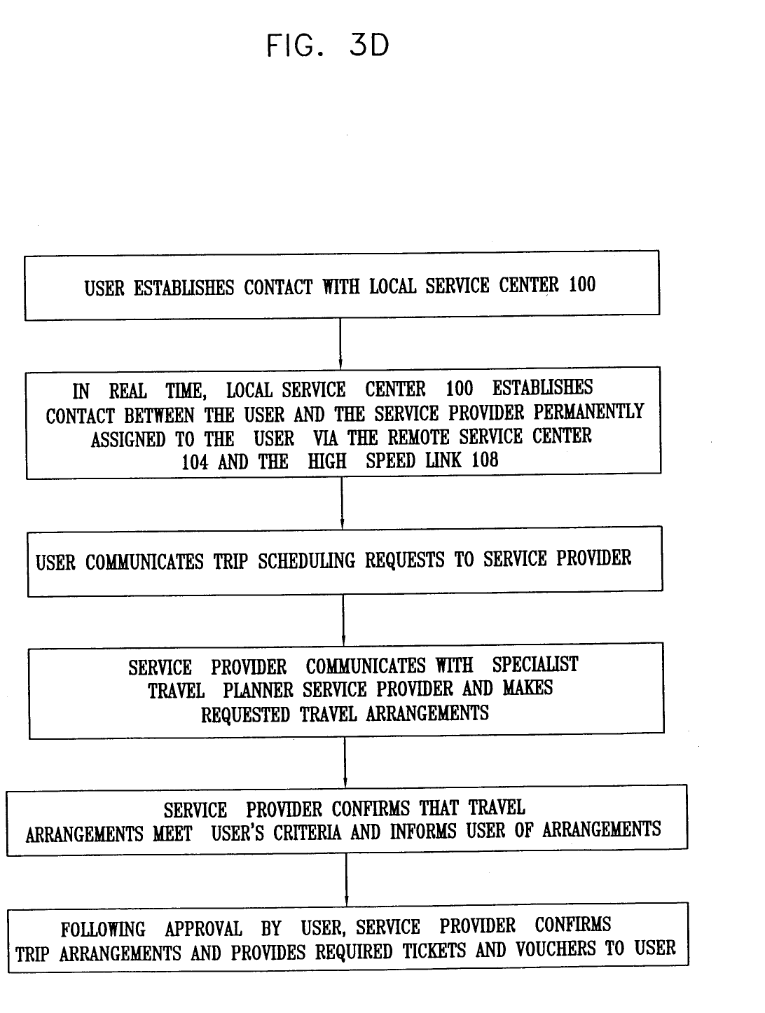

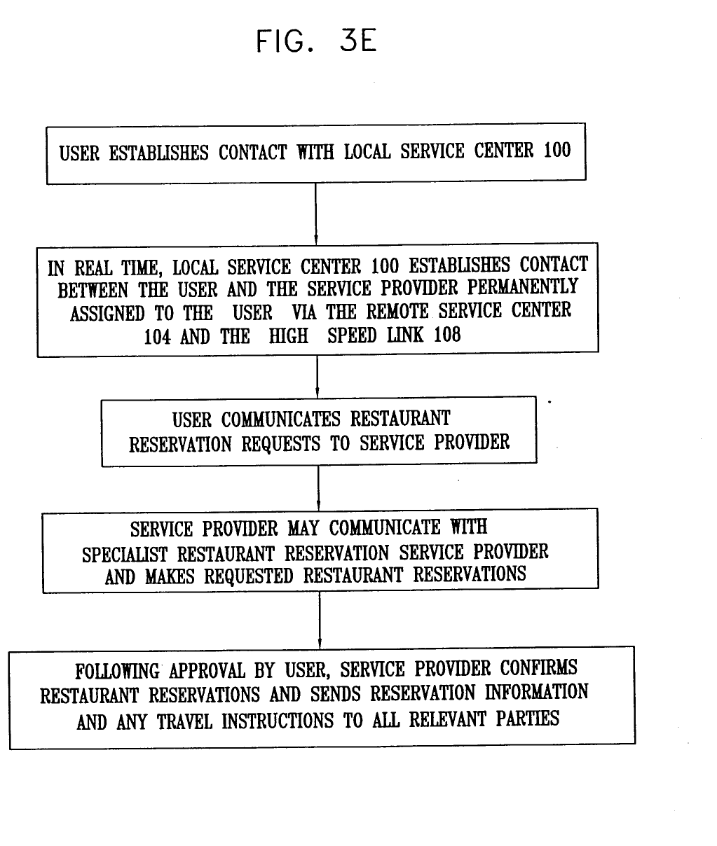

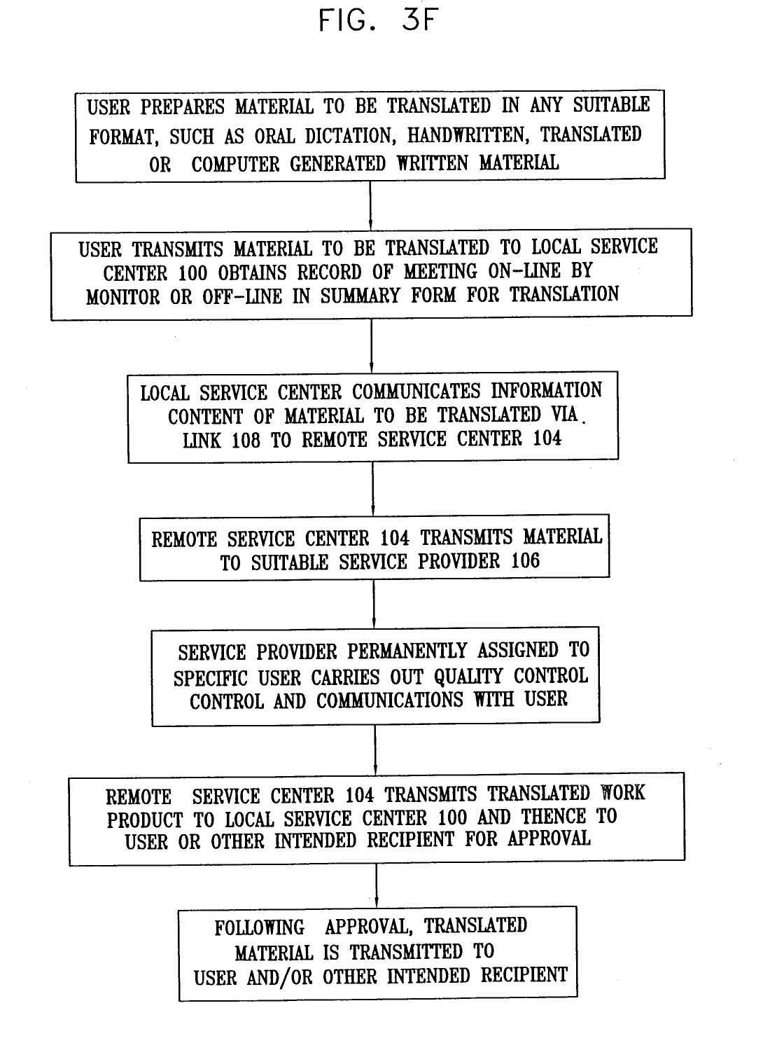

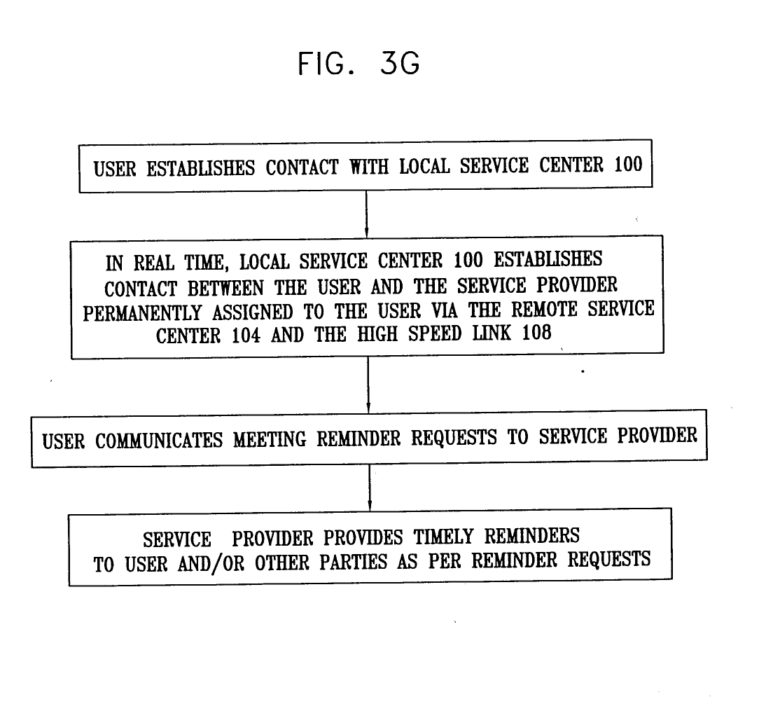

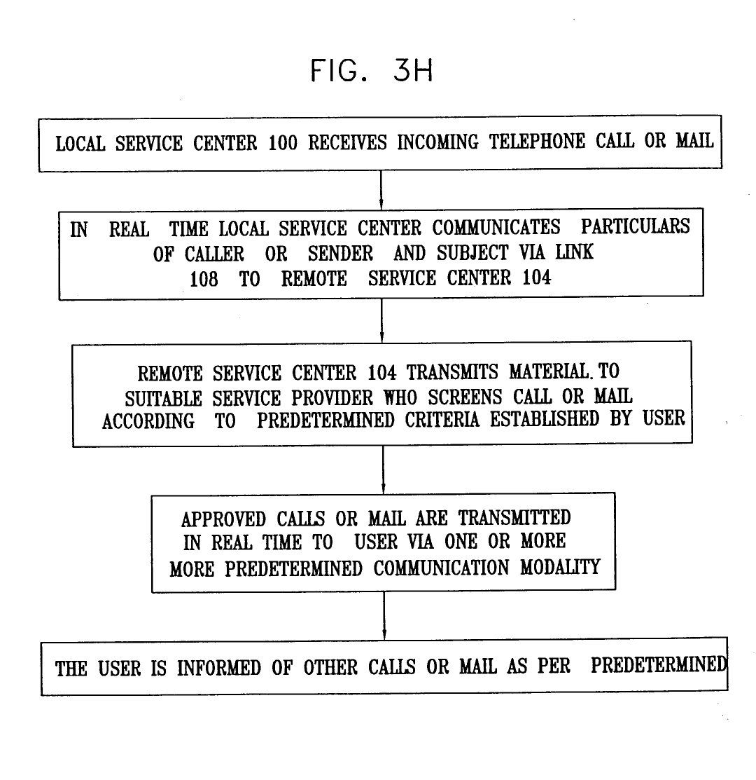

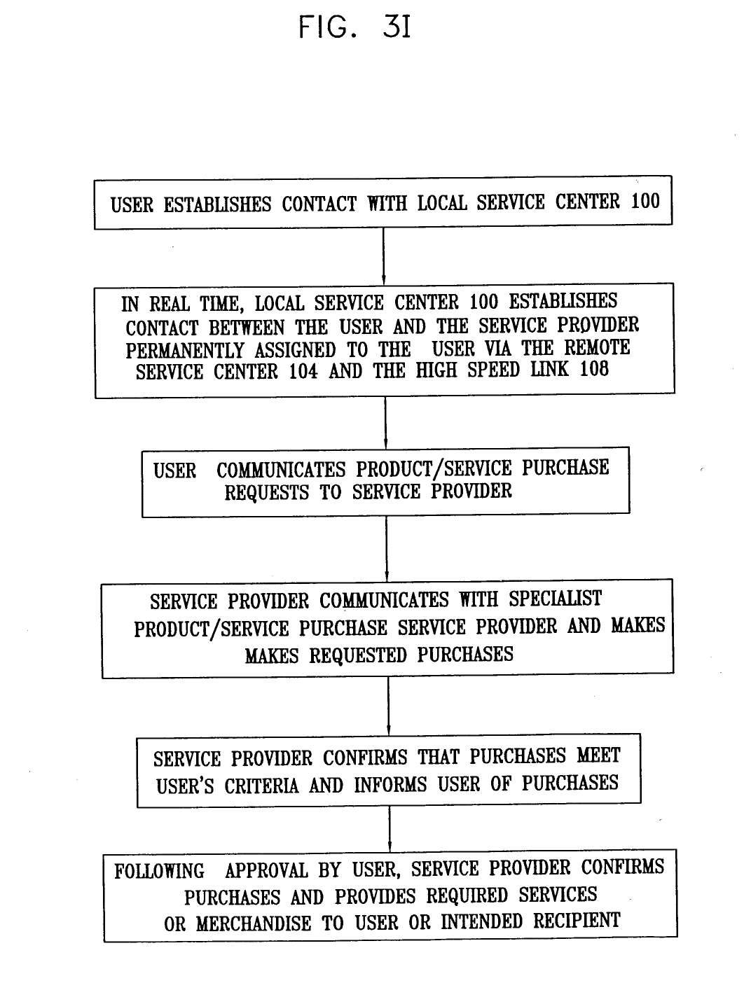

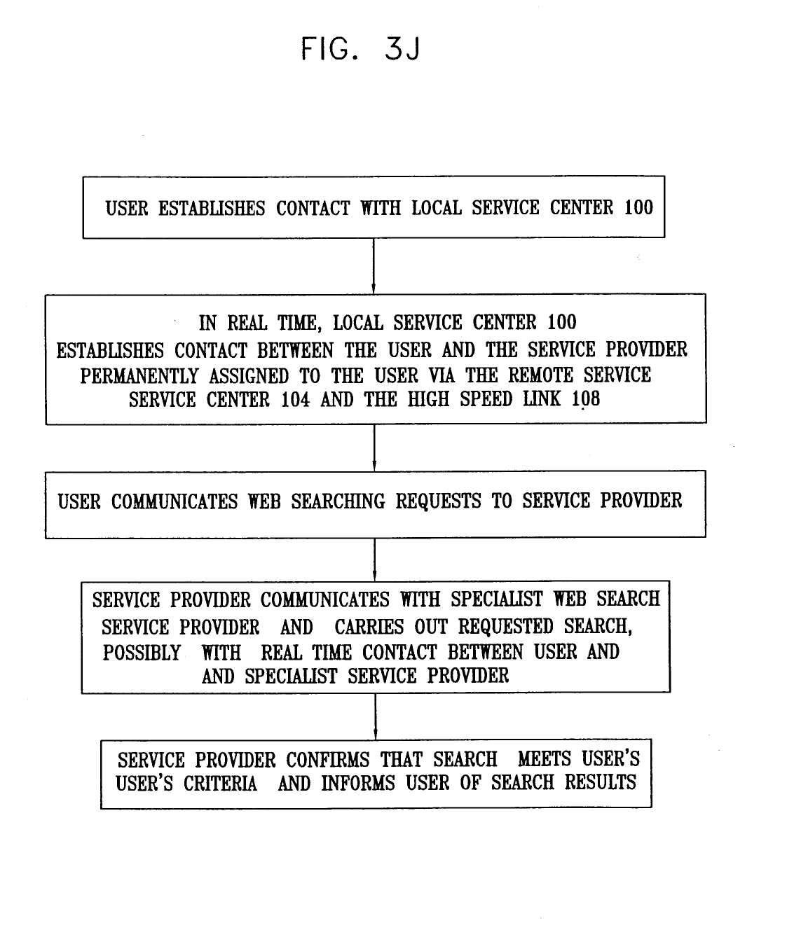

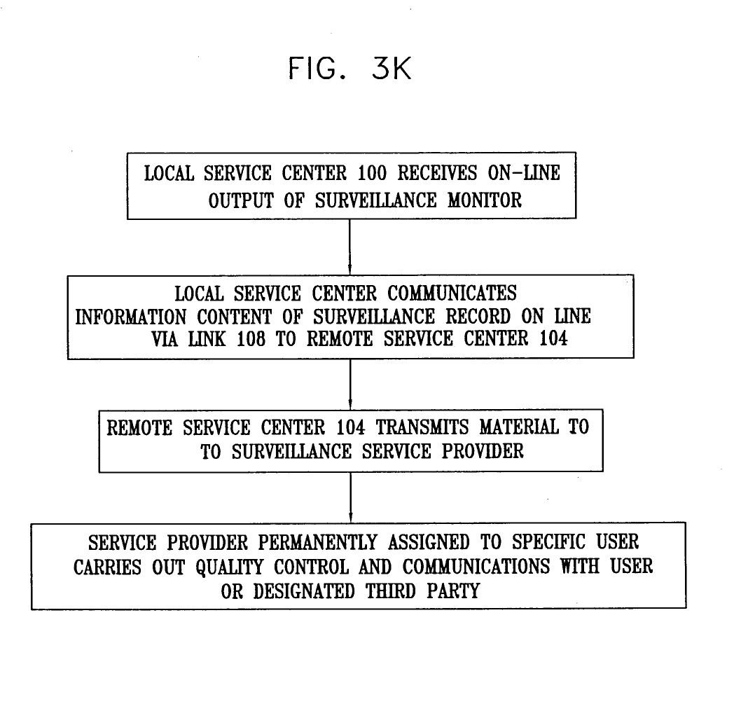

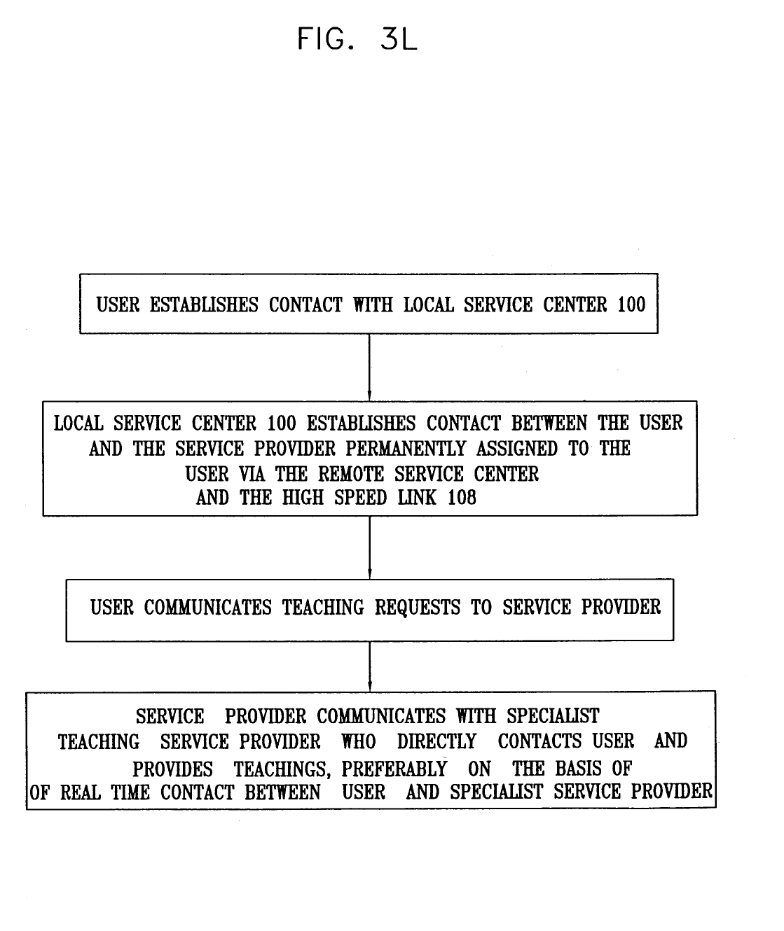

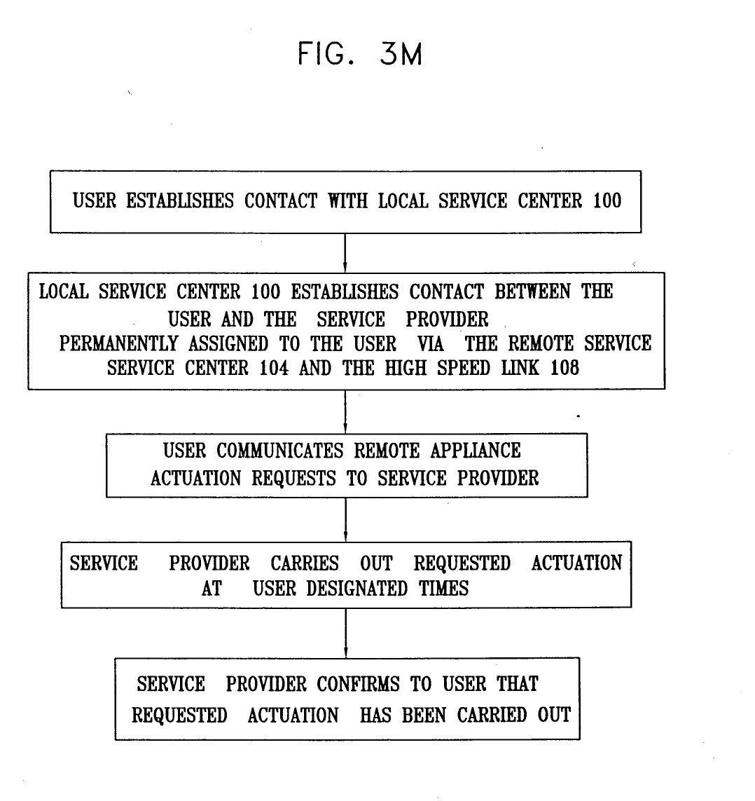

Reference is now made to FIG. 3A, which illustrates typical functionality for typing materials. As seen in FIG. 3A, a user may either dictate orally, send drafts by fax or e-mail, or otherwise communicate material to be typed to the local service center 100. The local service center 100 communicates the information content to be typed via at least partially dedicated high speed link 108 to remote service center 104, which transmits it to a service provider 106 competent to carry out the typing. This service provider 106 may be a user-specific service provider or alternatively may be a specialist typist service provider, who receives instructions from the user-specific service provider as to format, style and other parameters which are user-specific and are known to the user-specific service provider. The service provider 106 may also be a non-user-specific service provider (including a specialist typist service provider not under the supervision of a user-specific service provider, but at a possible cost in user convenience, as will be discussed below). It is preferable, however, in cases where the typing is not done by a user-specific service provider, and where such a user-specific service provider exists, that quality control on the work product be carried out by the user-specific service provider.

When the typed material has been appropriately checked, it is transmitted from the remote service center 104 via at least partially dedicated high speed link 108 to the local service center 100 and thence (possibly after quality control, which may be further quality control) to user 102 and, as appropriate, to other parties for their approval. Once the typed material has been approved, it may be sent directly to an addressee by an appropriate communication method.

Reference is now made to FIG. 3B, which illustrates typical functionality for preparing a transcript or protocol of a meeting or hearing. As seen in FIG. 3B, the local service center 100 may receive a record of the meeting via an on-line (i.e., real-time, near real-time, or to some degree simultaneous; while the meeting is occurring) or off-line monitor or may receive an on-line or off-line summary. The local service center 100 communicates the information content to be typed via high speed link 108 to remote service center 104, which transmits it to a service provider 106 competent to carry out the typing or transcription. This service provider may be a user-specific service provider or alternatively may be a specialist service provider, who receives instructions from a user-specific service provider as to format, style and other parameters that are user-specific, and which are known to the user-specific service provider. The service provider 106 may also be a non-user-specific service provider (including a specialist typist service provider not under the supervision of a user-specific service provider, but possibly at a cost in user convenience, as will be discussed below). It is preferable, however, in cases where the typing is not done by a user-specific service provider, and where such a user-specific service provider exists, that quality control on the work product be carried out by the user-specific service provider.

When the typed material has been appropriately checked, it is transmitted from the remote service center 104 via at least partially dedicated high speed link 108 to the local service center 100 and thence (possibly after quality control, which may be further quality control) to user 102 and, as appropriate, to other parties for their approval. This may be done on-line by using an appropriate display at the meeting or hearing. Once the typed material has been approved, it may be sent directly to one or more participants or other parties, as desired by user 102, by an appropriate communication method or methods.

Reference is now made to FIG. 3C, which illustrates typical functionality for scheduling meetings for a user. As seen in FIG. 3C, a user who wishes to schedule a meeting with a third party, or a third party who wishes to schedule a meeting with the user, establishes contact with a local service center 100. The local service center 100 establishes contact with a user-specific service provider via the remote service center 104 and at least partially dedicated high speed link 108.

The user-specific service provider confirms that the proposed meeting does not conflict with other items on the user's calendar and confirms that it is acceptable to the user and to all other interested parties. The user-specific service provider then notifies the user and all other interested parties of the date, time and location of the meeting, along with any other relevant information concerning the meeting.

Reference is now made to FIG. 3D, which illustrates typical functionality for scheduling trips for a user. As seen in FIG. 3D, a user who wishes to schedule a trip establishes contact with a local-service center 100. The local service center 100 establishes contact with a user-specific service provider via the remote service center 104 and at least partially dedicated high speed link 108. The user-specific service provider typically involves a specialist travel planner in making the required transportation and hotel reservations.

The user-specific service provider confirms that the reservations meet the user's established criteria and confirms that the trip as arranged is acceptable to the user and to any other interested parties. The user-specific service provider then provides the user with tickets and vouchers, as appropriate, together with a detailed itinerary covering all aspects of the trip.

Reference is now made to FIG. 3E, which illustrates typical functionality for making restaurant reservations for a user. As seen in FIG. 3E, a user who wishes to make restaurant reservations establishes contact with a local service center 100. The local service center 100 establishes contact with a user-specific service provider via the remote service center 104 and at least partially dedicated high speed link 108. The user-specific service provider typically involves a specialist restaurant reservations counselor in making the required restaurant reservations.

The user-specific service provider confirms that the reservations meet the user's established criteria and confirms that the reservations as arranged are acceptable to the user and any guests for whom contact information may have been provided to the user-specific service provider. The user-specific service provider then provides the user and his guests with details of the reservations as well as instructions as to how to reach the restaurant.

Reference is now made to FIG. 3F, which illustrates typical functionality for preparing a translation of a document, meeting or hearing. As seen in FIG. 3F, a local service center 100 may receive a record of, for example, a meeting via an on-line or off-line monitor or may receive, for example, a document to be translated on-line or off-line.

The local service center 100 communicates the information content to be translated via at least partially dedicated high speed link 108 to remote service center 104, which transmits it to a service provider 106 competent to carry out the translation. This service provider may be a user-specific service provider or alternatively may be a specialist translation service provider, who receives instructions from the user-specific service provider as to format, style and other parameters that are user-specific and are known to the user-specific service provider. The service provider 106 may also be a non-user-specific service provider (including a specialist typist service provider not under the supervision of a user-specific service provider, but again, possibly at a cost in user convenience, as will be discussed below). It is preferable, however, in cases where the typing is not done by a user-specific service provider, and where such a user-specific service provider exists, that quality control on the work product be carried out by the user-specific service provider.

When the translated material has been appropriately checked, it is transmitted from the remote service center 104 via at least partially dedicated high speed link 108 to the local service center 100 and thence (possibly after quality control, which may be further quality control) to user 102 and, as appropriate, to other parties for their approval. This may be done on-line by using an appropriate display at the meeting or hearing. Once the translated material has been approved, it may be sent directly to one or more participants by an appropriate communication method.

It is noted that on-line simultaneous oral translations may be provided using the invention by a remotely located simultaneous translator. Such simultaneous translations may be provided for a meeting, a hearing or even a telephone call, potentially involving more than one local service center and/or more than one remote service center and potentially providing multiple simultaneous translations.

Reference is now made to FIG. 3G, which illustrates typical functionality for providing reminder services for a user. As seen in FIG. 3G, a user who wishes to be reminded of one or more future events or occasions establishes contact with a local service center 100. The future event(s) or occasion(s) make be individual or recurring event(s) or occasion(s). The local service center 100 establishes contact with a user-specific service provider via the remote service center 104 and at least partially dedicated high speed link 108. The user-specific service provider notes the required reminders on a user-specific calendar and ensures that reminders are timely communicated to the user or to a third person that the user wishes to remind.

Reference is now made to FIG. 3H, which illustrates typical functionality for providing telephone call or e-mail screening services for a user. As seen in FIG. 3H, a user who wishes to have his telephone calls or e-mails screened arranges that they be communicated via a local service center 100, link 108, and a remote service center 104 to a user-specific service provider, who is familiar with the user's screening criteria. These criteria may be time-dependent and may instruct that incoming calls or e-mails be transmitted to a specific static or mobile telephone, pager or other communicator, for example.

The user-specific service provider applies the user's screening criteria and notes all incoming telephone calls and e-mails. The user-specific service provider immediately transmits to the user all telephone calls and e-mails fitting the current user-established criteria for immediate transmission.

Reference is now made to FIG. 3I, which illustrates typical functionality for making purchases of goods-or services for a user. As seen in FIG. 3I, a user who wishes to make a purchase of goods or services establishes contact with a local service center 100. The local service center 100 establishes contact with the user-specific service provider via remote service center 104 and at least partially dedicated high speed link 108. The user-specific service provider typically involves a specialist purchasing counselor in making the required purchases.

The user-specific service provider confirms that the purchases meet the user's established criteria, obtains any required authorizations from third parties, and confirms that the purchases are acceptable to the user. The user-specific service provider then accordingly charges a credit or debit account belonging to the user (or to which the user is otherwise authorized to charge and authorizes the user-specific service provider to charge) and arranges for delivery of the purchased goods or services.

Reference is now made to FIG. 3J, which illustrates typical functionality for web monitoring for a user. As seen in FIG. 3J, a user who wishes to have web monitoring carried out establishes contact with a local service center 100. The local service center 100 establishes contact with the user-specific service provider via a remote service center 104 and at least partially dedicated high speed link 108. The user-specific service provider typically involves a specialist web monitor. The user-specific service provider confirms that the monitoring criteria and results meet the user's established criteria and confirms that the monitoring criteria and results are acceptable to the user. The user-specific service provider then causes the web monitoring results to be supplied to the user.

Reference is now made to FIG. 3K, which illustrates typical functionality for providing remote surveillance of a desired object or location for a user. As seen in FIG. 3K, the user who wishes to have such surveillance carried out establishes contact with the local service center 100. The local service center 100 establishes contact with a user-specific service provider via a remote service center 104 and at least partially dedicated high speed link 108. The user-specific service provider typically involves a specialist surveillance monitor in carrying out the required surveillance.

The surveillance monitor typically monitors audio and/or video information from suitable visual and/or audio sensors at a given location and received via the local service center 100, the at least partially dedicated high speed link 108 and the remote service center 104. These sensors may be used for many purposes, such as to protect a facility or care for a person, such as a baby.

The user-specific service provider confirms that the surveillance meets the user's established criteria, obtains any required authorizations from third parties, and provides the user and/or any appropriate third party with immediate notification of events in accordance with predetermined surveillance criteria.

Reference is now made to FIG. 3L, which illustrates typical functionality for providing individual teaching for a user. As seen in FIG. 3L, a user who wishes to receive teaching services establishes contact with a local service center 100. The local service center 100 establishes contact with the user-specific service provider via the remote service center 104 and at least partially dedicated high speed link 108. The user-specific service provider typically involves a specialist teacher, depending on the subject matter involved.

The teaching is preferably carried out on the basis of real-time interaction between the specialist teacher and the user via the local and remote service centers and the at least partially dedicated high speed link (in addition to whatever communications medium or media link the specialist teacher and the user to their respective remote and local service centers).

Reference is now made to FIG. 3M, which illustrates typical functionality for remote appliance actuation for a user. As seen in FIG. 3M, the user who wishes to have appliances actuated remotely establishes contact with a local service center 100. The local service center 100 establishes contact with the user-specific service provider via the remote service center 104 and at least partially dedicated high speed link 108. The user-specific service provider typically effects the desired actuation.

The user-specific service provider confirms that the requested actuation has been carried out.

It will be appreciated by persons skilled in the art that most, if not all, of the services specified as being carried out by a user-specific service provider, like travel arrangements, restaurant reservations, and shopping, could also be performed by a non-user-specific service provider, without user-specific service provider involvement. The preferred embodiments described above involve a user-specific service provider for the reason of convenience to the user. For example, in the case of travel reservations, a user-specific service provider can have information on file about a given user's preferences (seat selections, travel times, special meals, etc.) and either make the necessary reservations, if able to, or provide the user's preferences to and oversee the making of arrangements by a non-user-specific service provider. In contrast, such information would have to be provided by the user each time the service were to be requested in the case of a non-user-specific service provider.

It will be appreciated by persons skilled in the art that the various examples provided hereinabove with reference to FIGS. 3A-3M are merely examples of a wide range of services that may be provided in accordance with the present invention. Additional examples, which are clearly not exhaustive, include, web site design, graphic design, patent searching, trademark searching, patent drafting, legal advice, product documentation drafting, engineering, and product user support.

It is appreciated that revenues from operation of the invention may, but need not necessarily be, derived from user fees. For example, commissions may be received from vendors of goods and services, advertising revenues may be realized from the display of banners, and revenue sharing may be realized from communications providers.

It will be appreciated by persons skilled in the art that the present invention is not limited by what has been particularly shown and described hereinabove. Rather the scope of the present invention includes both combinations and subcombinations of various features described hereinabove and in the drawings, as well as modifications and variations thereof that would occur to a person of ordinary skill in the art upon reading the foregoing description and which are not in the prior art.

I claim:

1. An integrated system for providing remote outsourcing of services, the system comprising:
at least one local service center located relatively near to users of services and being operative to communicate with the users via communications media;
at least one remote service center located relatively far from the users and communicating with service providers who are located closer to the remote service center than to at least most users; and
at least one at least partially dedicated communications link interconnecting the local and remote service centers;
wherein each of the service providers provides at least one service that may be provided remotely for the users, and wherein the service providers communicate their work product back to at least one of users and third parties via the at least one remote service center.

2. A system according to claim 1, wherein the service providers are located in one or more regions in which wages paid for performing said at least one service are typically lower than wages paid for the same at least one service in where the users are located.

3. A system according to claim 1, wherein the at least one service comprises at least one of the following services: typing, transcription, translating, travel agent services, ticket agent services, product purchasing, services purchasing, arrangements, scheduling meetings, restaurant reservations, call screening, call forwarding, providing reminders, e-mail screening, surveillance, actuation of appliances, teaching and web browsing.

4. A system according to claim 1, wherein the system provides at least one service at no cost or a cost less than its market value to the users.

5. A system according to claim 1, wherein at least one of the at least one local service center and the at least one remote service center is virtual.

6. A system according to claim 1, wherein communication between at least one user and the at least one local service center is multimedia communication.

7. A system according to claim 1, wherein communication between at least one service provider and the at least one remote service center is multimedia communication.

8. A system according to claim 1, wherein communication between at least one user and the at least one local service center is wireless communication.

9. A system according to claim 1, wherein communication between at least one service provider and the at least one remote service center is wireless communication.

10. A system according to claim 1, wherein the system provides real-time communications between at least one user and at least one service provider.

11. A system according to claim 1, wherein communication between at least one user and the at least one local service center is via the Internet.

12. A method for providing cost effective outsourcing of services, the method comprising:
communicating between at least one local service center located relatively near to users and users via communications media;
communicating between at least one remote service center located relatively far from the users and service providers who are located closer to the at least one remote service center than to most users; and
interconnecting the local and remote service centers via at least one at least partially dedicated communications link;
wherein each of the service providers provides at least one service that may be provided remotely for the users, and wherein the service providers communicate their work product back to at least one of users and third parties via the at least one remote service center.

13. A method according to claim 12, wherein the service providers are located in one or more regions in which wages paid for performing said at least one service are typically lower than wages paid for the same at least one service in where the users are located.

14. A method according to claim 12, wherein the at least one service comprises at least one of the following services: typing, transcription, translating, travel agent services, ticket agent services, product purchasing, services purchasing, arrangements, scheduling meetings, restaurant reservations, call screening, call forwarding, providing reminders, e-mail screening, surveillance, actuation of appliances, teaching and web browsing.

15. A method according to claim 12, wherein the at least one service is provided at no cost or a cost less than its market value to the users.

16. A method according to claim 12, wherein at least one of the at least one local service center and the at least one remote service center is virtual.

17. A method according to claim 12, wherein the step of communicating between the at least one local service center and users comprises the step of multimedia communication between the at least one local service center and at least one user.

18. A method according to claim 12, wherein the step of communicating between the at least one remote service center and service providers comprises the step of multimedia communication between at least one service provider and the at least one remote service center.

19. A method according to claim 12, wherein the step of communicating between the at least one local service center and users comprises the step of wireless communication between at least one user and the at least one local service center.

20. A method according to claim 12, wherein the step of communicating between the at least one remote service center and service providers comprises the step of wireless communication between at least one service provider and the at least one remote service center.

21. A method according to claim 12, further comprising the step of providing real-time communications between at least one user and at least one service provider.

22. A method according to claim 12, wherein the step of communicating between the at least one local service center and users comprises the step of communicating between at least one user and the at least one local service center via the Internet.

23. A method according to claim 12, further comprising the step of obtaining revenues via at least one of advertising and commissions.

24. A method according to claim 12, further comprising the step of associating at least one user with a user-specific service provider.

25. A method according to claim 24, further comprising the step of:
arranging, by the user-specific service provider, for at least one service to be provided to the user by another service provider.

26. A method according to claim 25, further comprising the step of:
providing quality control, by the user-specific service provider, of work product produced by the other service provider.

27. A method according to claim 12, further comprising the step of providing quality control.

28. A method according to claim 27, wherein the step of providing quality control comprises the step of providing quality control at a remote service center side of the system, wherein a remote service center side of the system refers to a remote service center and service providers communicating with the remote service center.

29. A method according to claim 27, wherein the step of providing quality control comprises the step of providing quality control by a local service center.

30. A system according to claim 1, wherein the work product is communicated to at least one of users and third parties from the at least one remote service center via the at least one at least partially dedicated communication link, and from the at least one at least partially dedicated communication link via the at least one local service center.

31. A method according to claim 12, wherein the work product is communicated to at least one of users and third parties from the at least one remote service center via the at least one at least partially dedicated communication link, and from the at least one at least partially dedicated communication link via the at least one local-service center.
